(19) United States
(12) Patent Application Publication
(10) Pub. No.: US 2011/0153683 A1
(43) Pub. Date: Jun. 23, 2011

(54) METHOD AND SYSTEM FOR GENERATING VISUAL REPRESENTATIONS OF DATA

(76) Inventor: R. Andrew Hoskinson, Reston, VA (US)

(21) Appl. No.: 12/644,206

(22) Filed: Dec. 22, 2009

(51) Int. Cl. G06F 17/30; G06F 17/00; G06F 3/048

(52) U.S. Cl. 707/805; 707/812; 707/E17.018; 707/E17.03; 707/E17.032; 707/E17.044

(57) ABSTRACT

A computer-implemented method for generating visual representations of data. The method aggregates data from multiple data sources, where the data sources are organized in multiple data formats. The data is converted to a predetermined format and stored in a centralized database. The data is analyzed by associating data elements and analysis outputs with geographical factors. The method generates visual representations of the analyzed data based on one or more parameters.

### TECHNICAL FIELD

The present disclosure generally relates to electronic data aggregation and analysis. More particularly, the disclosure relates to generating visual representations of analyzed data.

### BACKGROUND

Interpreting data from numerous, non-homogenous sources is typically a complex task. Content from disparate data sources can have different formats, making integration and interpretation difficult and cumbersome.

Consider the American Recovery and Reinvestment Act (ARRA) of the United States government, a far-reaching piece of legislation that includes federal tax cuts, expansion of unemployment benefits, and other social welfare provisions, as well as domestic spending in education, health care, and infrastructure, including the energy sector. This legislation not only aims to stimulate the US economy in the wake of a severe economic downturn, but it also seeks to foster high levels of accountability and transparency in government spending, a task that requires gathering massive quantities of data from disparate sources, ranging from financial systems to stimulus funding recipients. The ARRA mandates that all spending information be publicly available and transparent, allowing taxpayers to track funds at the street level. Attaining such transparency requires recipients of stimulus funding to report the amount of monies spent, the status of the stimulus funding, the number of jobs created, avoided, or saved, and other details. If these goals are achieved, the public will be able to track the total $787 billion stimulus funding and how it is being spent. Accessing such data from disparate data sources is complicated and encumbered by a number of inherent obstacles, such as differing data formats and the sheer quantity of data.

Further, analyzing the retrieved data involves mutually associating and relating large data sets. Several aggregations may be required, first to convert data into information through analysis and then to improve understandability by developing a meaningful, easily interpretable visual representation.

Faced with a task of accessing massive data from multiple data sources, it would be highly desirable to have a consolidated system for aggregating huge amounts of data from disparate data sources, performing analysis, and generating meaningful, easily interpretable visual representations of the data.

### SUMMARY

According to aspects illustrated herein, there is provided a computer-implemented method for representing data. The method aggregates data from multiple data sources, which may be organized in multiple data formats. The data is converted to a predetermined format followed by its storage in a centralized database. The data is analyzed, including associating data elements and analysis outputs with geographical factors, and visual representations of the analyzed data are generated based on one or more predetermined parameters.

Another embodiment of the present disclosure describes a computer-implemented system for visual representation of data. The system includes a data aggregation module for aggregating data from multiple data sources, which may be organized in multiple data formats. The system further includes a data storage module, which includes a centralized database for storing the aggregated data, which is converted to a predetermined format before storage. An analysis module associates data elements and analysis outputs with one or more geographical factors. The system employs a network for transmitting the analyzed data. The system further includes a user interface for viewing visual representations of the analyzed data.

Another embodiment of the present disclosure describes a computer-implemented method for representing data. The method aggregates data from multiple data sources, which may be organized in multiple data formats. The data is converted to a predetermined format followed by its storage in a centralized database. The data is analyzed, including associating data elements and analysis outputs with one or more geographical factors. Further, visual representations of the analyzed data, including a geospatial representation, are generated and viewed. The method further zooms in or out of a particular geographic location within the geospatial representation and visual representations of the analyzed data, related to the particular geographic location, can be observed.

### BRIEF DESCRIPTION OF THE DRAWINGS

The drawing figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a flowchart of an exemplary computer-implemented method for generating visual representations of data.

FIG. 2 is a flowchart of an exemplary computer-implemented method for generating visual representations through a geospatial representation.

FIG. 3 depicts an exemplary embodiment of a computer-implemented system for aggregating and generating visual representations of data.

FIG. 4 is an exemplary embodiment of a computer-implemented system for generating an ARRA reporting environment.

FIG. 5 demonstrates an exemplary screenshot of a stimulus-spending summary for the state of California.

FIG. 6 exhibits an exemplary screenshot of detailed stimulus-spending summary.

FIG. 7 displays an exemplary screenshot of an agency scorecard.

FIG. 8 exhibits an exemplary embodiment of a geospatial representation of the United States.

FIG. 9 is an alternate embodiment of the geospatial representation of FIG. 8.

FIG. 10 displays an exemplary screenshot of alerts and notifications.

FIG. 11 exhibits an exemplary screenshot of a data entry form.

### DETAILED DESCRIPTION

The following detailed description is made with reference to the figures. Exemplary embodiments are described to illustrate the subject matter of the disclosure, not to limit its scope, which is defined by the appended claims.

### DEFINITIONS

The following terms are used throughout this document and are defined here for clarity and convenience.

### Disparate Data Sources

The term ‘disparate data sources’ represents different sources of data, which may be any device or network location capable of providing access to data of a particular data type. Examples of disparate data sources include servers serving up files, web sites, users and so on, well known to those of skill in the art. Different data sources can employ different data formats such as database management system (DBMS) files, relational database management system (RDBMS) files, markup language documents, word processing documents, spreadsheet documents, and so on, widely known in the art. The distinctions that define the disparate data formats may also include a difference in file format, location of the data source, and other distinctions as will be readily understood by those of skill in the art.

### Extranet

An “extranet” is a computer network that allows controlled access from outside to an otherwise private network, enabling business-to-business transactions and file sharing for specific business, educational, or other purposes.

### Keyhole Markup Language (KML)

KML is an XML-based (eXtensible markup language) language schema for expressing geographic annotation and visualization on Earth browsers. In other words, KML is a file format used to display geographic data in an Earth browser (Earth browser is an earth simulation that combines an easy to navigate, 3-dimensional globe with real-time data) such as Google Earth, Google Maps, and Google Maps for cell phones. A KML file specifies a set of features (placemarks, images, polygons, 3D models, textual descriptions, and the like) for display in an Earth browser (geobrowser) implementing the KML encoding. Each location's longitude, latitude, and other data such as tilt, heading, and altitude, together define a “camera view”, which can make the view more specific.

### Data Feed

A data feed is an electronic transmission of data from one server to another. It is a mechanism for users to receive updated data from data sources. It is commonly used by real-time applications in point-to-point settings as well as on the worldwide web.

### Geospatial Representation

A geospatial representation is a virtual globe, map, or geographic information depiction that enables high compression ratios while preserving user precision and accuracy requirements. The geospatial representation displays actual images of ground terrain as seen from a viewpoint, which can be chosen interactively. Examples include digital maps and models of terrain.

### Java Database Connectivity (JDBC)

The JDBC is an industry standard application-programming interface (API) for database-independent connectivity between the Java programming language and a wide range of databases—structured query language (SQL) databases and other tabular data sources, such as spreadsheets or flat files. Since nearly all RDBMSs support SQL, and because Java itself runs on most platforms, JDBC makes it possible to write a single database application that can run on different platforms and interact with different DBMSs.

### DESCRIPTION OF EXEMPLARY EMBODIMENTS

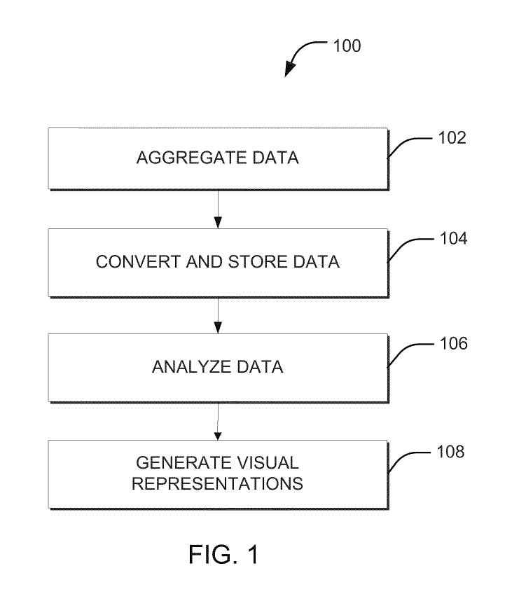

FIG. 1 illustrates a flowchart of an exemplary computer-implemented method 100 for generating visual representations of data. The method 100 aggregates and analyzes the data and then generates convincing visual representations of the data, which may include a graphical chart, a map, a balanced scorecard, a notification, an alert, an icon, or a color coded graphic. It will be obvious to those skilled in the art that several conceivable visual representations may be generated without departing from the scope and intended functions of the claimed invention.

The data from disparate data sources is aggregated at step 102. This may involve gathering the data from the disparate data sources periodically or alternatively, the data may be gathered in real time from the disparate data sources. Examples of the disparate data sources include servers storing files, web sites, and the like, well known to those of skill in the art. The disparate data sources can be located at geographically diverse locations and may be any DBMS supporting JDBC standard. Additionally, a user may also serve as one of the disparate data sources, where the user can supply data directly to a centralized database through a user interface having an input device, such as a keyboard or a touch-screen, a storage device, and a display device.

The data aggregated from the disparate data sources is converted to a predetermined format and stored on the centralized database at step 104. Format conversion may involve normalizing the aggregated data, including change of file formats and data formats to predetermined formats. Alternatively, the data from the disparate data sources may be in the predetermined format. In this scenario, the data is directly stored on the centralized database at step 104, obviating the need for any format conversion.

The data is analyzed by associating data elements and analysis outputs with geographical factors at step 106. The analysis outputs may be generated by comparing two or more data elements. The geographical factor can be a zip code, a geographic location, or any other geographic factor, without departing from the scope of the claims. For example, a user can associate and analyze multiple data elements—funding received, pending funds, and can generate the visual representation—a pie chart, with the geographical factor—California. At step 108, based on one or more predetermined parameters, visual representations of the analyzed data are generated. The predetermined parameters may include a keyword, a timeline, a threshold, a recipient, a category, a government agency, a financial agency, or other such parameters. The category parameter may include a funding category. The visual representations may be viewed on a web-based interface. For example, a user can observe the visual representations on a cell phone or a personal computer with internet access. Presenting the data in the form of visual representations on the web-based interface enhances the understandability of the data for the user. Further, the visual representations generated are highly malleable and customizable to suit user requirement. Data feeds of the analyzed data may be created from the centralized database to the web-based interface.

In a particular exemplary configuration, the centralized database resides on an application server, which is a J2EE (Java 2 Enterprise Edition) server. Alternate configurations of servers such as another form of Java Enterprise Edition server (JBoss application server product), Apache Tomcat, and so on, may be employed. The exemplary storage mechanism storing the data in the centralized database may include a flat file, relational database, markup language, XML file, or other suitable persistent storage mechanisms. Alternatively, the visual representations can be stored on a computer-readable medium such as a CD, DVD, or other similar storage media and viewed later.

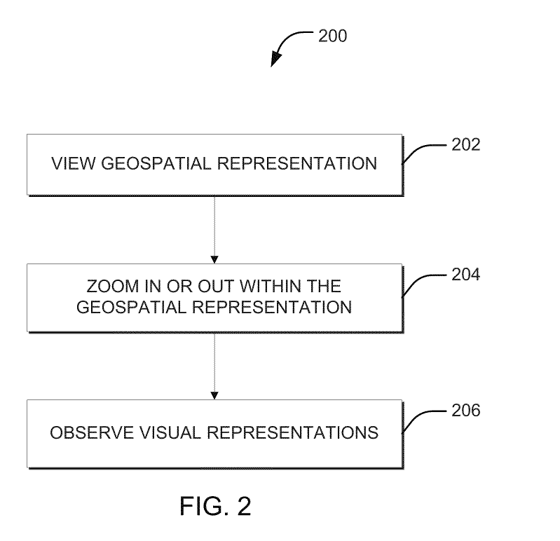

FIG. 2 illustrates a flowchart of an exemplary computer-implemented method 200 for generating visual representations through a geospatial representation. The method 200 involves viewing a generated visual representation, which is a geospatial representation, at step 202. Further, step 204 involves zooming in or out of the geospatial representation to a particular geographic location within the geospatial representation. Alternatively, a user can traverse through the geospatial representation by double clicking, mouse dragging, searching, or other similar inputs, well known in the art. The user can perform a search and generate visual representations based on predetermined parameters such a state, a city, a zip code, or a recipient name, which will yield information for that particular state, city, zip code area, or recipient. Further, the searching can be performed based on various other predetermined parameters, including a keyword, a timeline, a threshold, a category, a government agency, a financial agency, or other such parameters, without departing from the intended scope of the claims. The category parameter may include a funding category. The visual representations of analyzed data related to the particular geographic location are observed at step 206.

In one embodiment of the present disclosure, the geospatial representation is a map. Creating such a map involves KML integration, which helps build an effective, three-dimensional, pictorial view of the geographic location. A user can zoom from a larger view, such as the map of the United States, down to details of individual projects in specific areas and can perform a state search, yielding information on jobs created and/or saved in congressional districts, the top recipients of stimulus funding, the top infrastructure recipients and so on. The user can perform searches and generate visual representations based on predetermined parameters such as state, city, zip code, or recipient, which will yield information for that particular state, city, zip code area, or recipient, respectively. The predetermined parameters may include a keyword, a timeline, a threshold, a recipient, a category, a government agency, a financial agency, or other such parameters, without departing from the intended scope of the claims. For example, a user can view a geospatial representation for the US, zoom in to view details for the state of Florida, and further zoom in to view specific details of the city of Jacksonville. The user may view details, such as number of jobs created or saved, stimulus funding received, and so on in Jacksonville, Fla.

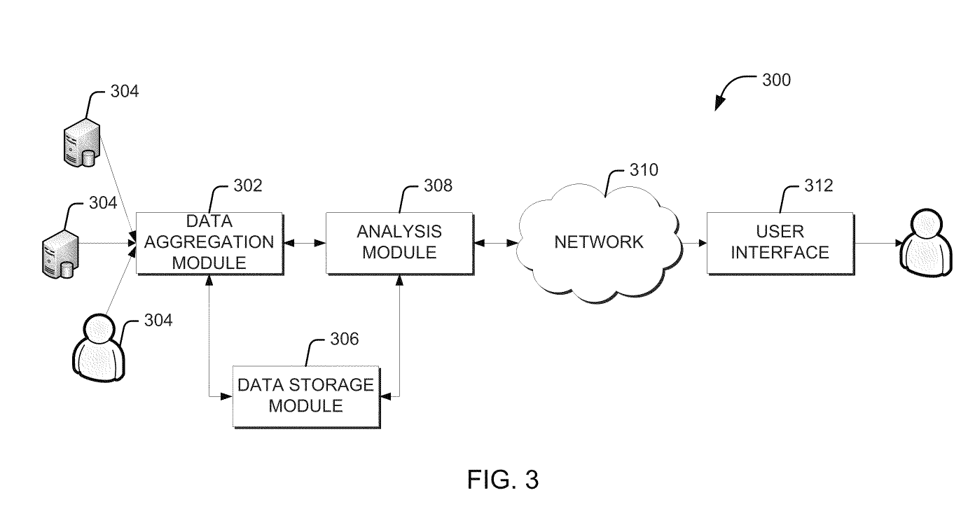

FIG. 3 depicts an embodiment of a computer-implemented system 300 for generating visual representations of data. The system 300 gathers the data and generates visual representations by performing analysis on the gathered data. A data aggregation module 302 gathers data from disparate data sources 304. The disparate data sources 304 may include a user, servers serving up files, web sites, and so on, well known to those of skill in the art. A data storage module 306 converts the gathered data, with inconsistent data formats, to a predetermined format and stores the converted data in a centralized database. Alternatively, the data from the disparate data sources may be in the predetermined format. In this scenario, the data is directly stored on the centralized database, eliminating the need of any format conversion. Format conversion may further involve normalizing the aggregated data, including change of file formats, and data formats to predetermined formats, removing duplicates, associating each data entry with a unique value, and the like. An analysis module 308 performs analysis on the stored data and generates visual representations. The generated visual representations are transmitted over a secure channel on network 310 to a user interface 312, which can be viewed by a user 314.

The network 310, as described for the system 300, can be an extranet, a cellular telephone network, a local area network (LAN), or any other network, well known in the art. Secure data transmission can be performed by implementing various encryption techniques, as will be apparent to those having skill in the art.

In an exemplary embodiment, the system 300 is implemented to provide greater transparency in the American Recovery and Reinvestment Act (ARRA) of the United States government. The system 300 generates visual representations to track the amount of monies spent, the status of a project, the number of jobs created or saved, and other details, allowing the public to track the stimulus funding. The visual representations are highly malleable and customizable according to the user requirement.

The explanation of the following figures is with reference to the ARRA environment described above.

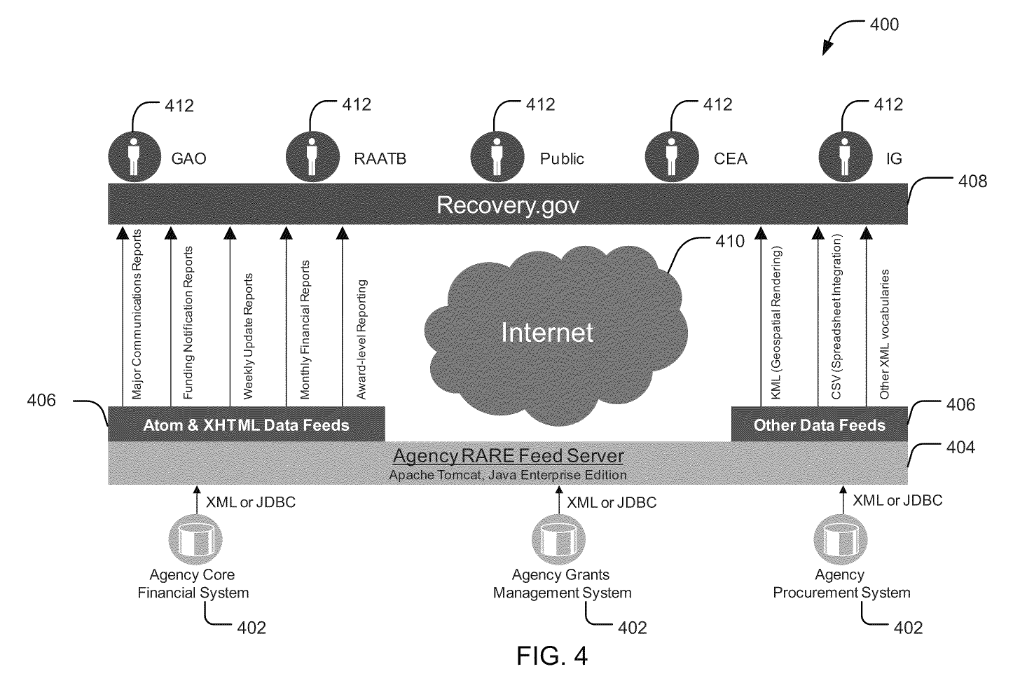

FIG. 4 is an exemplary embodiment of a computer-implemented system 400 for generating an ARRA reporting environment. The system 400 enhances transparency in the stimulus fund tracking by generating a user-friendly, understandable reporting environment. ARRA data elements are extracted from disparate data sources 402 including various federal agency financial systems, such as agency core system, agency grants management system, and agency procurement system. Further, the disparate data sources 402 may include servers storing files, web sites, and so on, well known to those of skill in the art. This may involve gathering the data from the disparate data sources 402 periodically or alternatively, the data may be gathered in real time from the disparate data sources 402. The disparate data sources 402 may be located at geographically diverse locations and may be any DBMS supporting the JDBC standard. Additionally, a user can also serve as one of the disparate data sources 402, where the user may supply data directly to a centralized database through a user interface. The user interface may have an input device, such as a keyboard or a touch-screen, a storage device, and a display device, so that the user can key-in the data. An agency RARE (Recovery Act Reporting Environment) feed server 404 gathers the data from the disparate data sources 402. The data gathered from the disparate data sources 402 is converted to a predetermined format and stored on the agency RARE feed server 404.

Data feeds 406 can be created to feed data to a website 408 from the agency RARE feed server 404. The data feeds 406 may take the form of communication reports, funding notification reports, weekly update reports, monthly financial reports, award-level reporting, geospatial rendering (KML), spreadsheet integration, and other XML vocabularies. A network 410 supports transmission of the data feeds 406 to the website 408. The system 400 generates meaningful, easily interpretable visual representations of the data that can be viewed by users 412 of the website 408. The users 412 include Inspector General (IG), Council of Economic Advisors (CEA), Recovery Act Accountability and Transparency Board (RAATB), Government Accountability Office (GAO), and the public. The visual representations can be generated by associating data elements and analysis outputs with geographical factors such as a zip code, a geographic location, and so on. The geographical location can be a city, a state, and so on. For example, the users 412 can generate a geospatial representation depicting the top three recipients creating the maximum number of jobs in Florida. The users 412 can generate a geospatial representation—a map, by associating data elements—number of jobs created, and recipient names and an analysis output—top three recipients creating maximum jobs, with geographic location—Florida. This geospatial representation may further include visual representations in the form of three icons depicting the location of those top three recipients.

In one embodiment, the data can be collected from any database product supporting the JDBC standard including MS-Access, MS-SQL, MySQL, and other similar database products.

In one implementation, the agency RARE feed server 404 is an Apache Tomcat server and the network 410 is an internet. In another implementation, the agency RARE feed server 404 is another type of Java Enterprise Edition server (such as the JBoss application server product) and the network 410 is an extranet.

Visual representations, including a graphical chart, a map, a balanced scorecard, a notification, an alert, an icon, a geospatial representation, a color coded graphic, or other similar representations characterizing similar information, can be employed for representing the analyzed data. Presenting the data in the form of visual representations on the website 408 enhances the understandability of data for the users 412. Additionally, the visual representations generated are highly malleable and customizable according to the user requirement. Further, several similar implementations of the system 400 are possible without departing from the scope of the claims.

The system 400 facilitates tracking the money spent under the stimulus-funding program in a particular community or state. Similarly, the users 412 can also track benefitted recipients and their location, number of jobs created or saved nationally or in a particular state, city, or zip code. While viewing the visual representation, the user 412 can locate precisely how many contract, grant, and loan recipient awards have been made, for example, in a particular state. The users 412 can view the jobs created or saved and the total value of the awards. The state search will yield information on jobs created or saved in congressional districts, the top recipients of stimulus funding, the top infrastructure recipients, and so on.

In addition to viewing the visual representations, the users 412 can also access the data behind the visual representations. For example, the users 412 can access files containing recipient contracts, grants, and loan data in XML, CSV (comma separated values), and XLS (Microsoft excel) formats from the website 408, allowing greater flexibility in accessing data. Additionally, the users 412 can also download a list of recipients that failed to submit reports on time, as required by the ARRA.

In one embodiment, the website 408 includes a search interface. The users 412 can generate visual representations based on predetermined parameters (such as name of a stimulus-funding recipient). For example, the user 412 can search for a recipient name in the search interface and the system 400 will create visual representations including data from every report containing that recipient's name. Additionally, other information about the recipient may be listed for view. The search interface may include a search box, a dropdown list, or any other method of searching well known in the art. In an alternate embodiment, the user 412 can perform a keyword search. For example, the user 412 can type in the name of a federal agency and view a list of its stimulus funding recipients. Further, the keyword can be a recipient name, an agency name, and the like. Alternatively, the user 412 can generate visual representations based on various predetermined parameters, including a keyword, a timeline, a threshold, a recipient, a category, a government agency, a financial agency, or other such parameters, without departing from the scope of the claims. The category parameter may include a funding category.

In another embodiment, the visual representations include an online tool for reporting any suspected fraud, waste, or abuse related to stimulus funding and projects. Additionally, the visual representations may include a feedback form. The system 400 allows the user 412 to provide feedback through the feedback form, facilitating improvements for the website 408 based on user feedback, for continuous enhancement and refinement of the website 408.

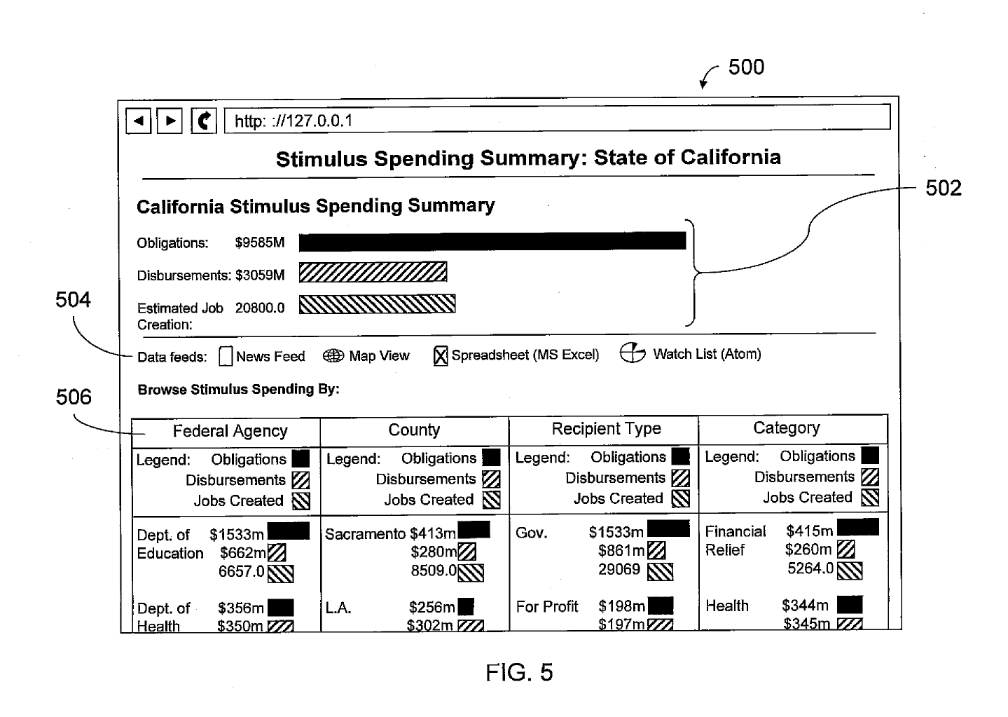

FIG. 5 is an exemplary screenshot 500 of a stimulus-spending summary for the state of California. The screenshot 500 is a visual representation including a bar graph 502 having three legends representing obligations, disbursements, and estimated job creation (based on number of jobs created or saved) for California. The geographic location—California can be associated with data elements—obligations, disbursements, and estimated number of jobs created to generate a visual representation—the bar graph 502. Data feeds 504 include News Feed, Map View, Spreadsheet, Watch List, and so on. The data feeds 504 are created from the agency RARE feed server 404 to the website 408. Table 506 provides another visual representation including various browsing options for tracking the stimulus package including Federal Agency, County, Recipient Type, Category, and so on. The category parameter may include a funding category. Through these browsing options, a user can track obligations, disbursements, and jobs created or saved in the form of a bar graph, as described for California. The browsing options have divisions at diverse levels of hierarchy, where a user can browse visual representations or more specifically, bar graphs. For example, while browsing through a Federal Agency bar graph, a user can browse through similar bar graphs for various departments of a federal agency, such as Department of Education, Department of Health and Human Services, Department of Housing and Urban Development, and so on. Likewise, those skilled in the art will apprehend that several conceivable visual representations including a graphical chart, a map, a balanced scorecard, a notification, an alert, an icon, a color coded graphic, or other similar representations characterizing similar information, may be generated without departing from the scope and intended functions of the claimed invention.

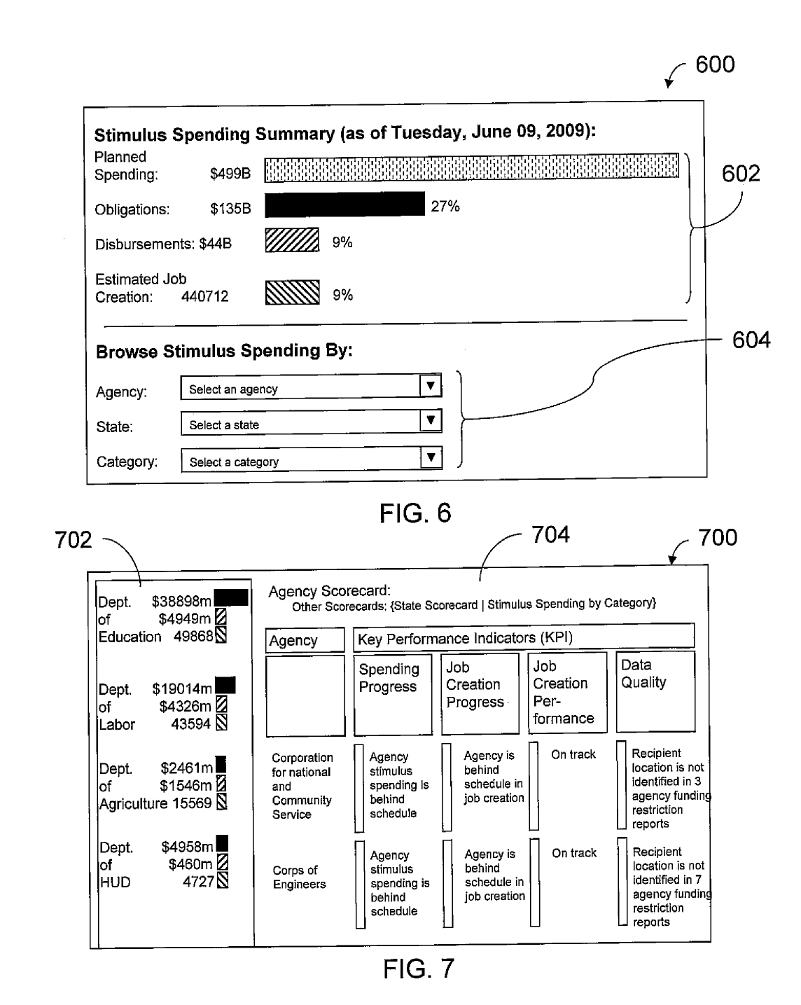

FIG. 6 exhibits an exemplary screenshot 600 of detailed stimulus-spending summary. The screenshot 600 is a detailed depiction of stimulus spending on a particular day. A bar graph (a visual representation) 602, having four legends (data elements)—Planned Spending, Obligations, Disbursements, and Estimated Job Creation, describes stimulus-spending summary in detail. The job creation is estimated based on a mathematical algorithm using economic assumptions published by the White House. A browsing section, another visual representation, enables stimulus spending browsing by predetermined parameters 604 including agency, state, category, and so on. The category parameter may include a funding category. The agency parameter may include a government agency or a financial agency. As will be evident to those having skill in the art, the bar graph 602 may include any number of legends (data elements) and the predetermined parameters 604 may include a keyword, a timeline, a threshold, a recipient, a category, a government agency, a financial agency, or other such parameters.

FIG. 7 displays an exemplary screenshot 700 of an agency scorecard. Such federal agency scorecards can be generated by selecting a predetermined parameter, such as the name of a federal agency or by selecting federal agency departments from the drop down list of the search interface, as described earlier in relation with the system 400. The screenshot 700 represents an agency scorecard having two vertical sections—a left section 702 and a right section 704. The left section 702 provides an overview of stimulus spending in multiple departments of the Federal Agency, while the right section 704 rates various agency departments, such as Corporation for National and Community Service, Corps of Engineers, and so on, based on several factors and provides a qualitative summary to users. These factors, known as Key Performance Indicators (KPI), include Spending Progress, Job Creation Progress, Job Creation Performance, and Data Quality. As will be understood by those skilled in the art, several other factors can be used to provide a qualitative summary to the users without departing from the intended scope of the claimed invention. The right section 704 also contains hyperlinked tabs to other scorecards, including state scorecard and stimulus spending by category, where the category may include a funding category. Further, several other visual representations, including a graphical chart, a map, a balanced scorecard, a notification, an alert, an icon, a color coded graphic, or other similar representations for depicting similar information, are possible without departing from the intended scope of the claims.

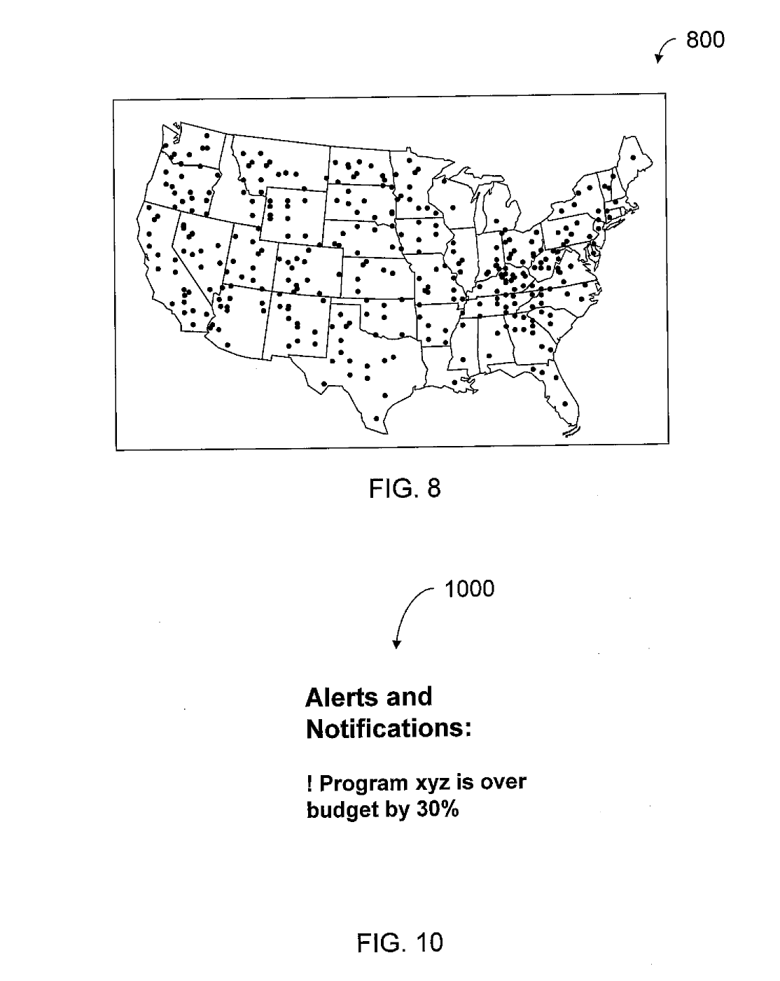

FIG. 8 exhibits an exemplary embodiment of a geospatial representation 800 of the US. The geospatial representation 800 facilitates tracking of the stimulus spending in a particular community or state, benefitted recipients and their location, number of jobs created and/or saved nationally or in a particular state, city, or zip code. The geospatial representation 800 reveals a geospatial view having icons representing every geographic area of the US where the stimulus spending has occurred. The icons are visual representations within the geospatial representation 800 and show the number of jobs created or saved in that particular geographic area. While viewing the geospatial representation 800, a user can locate precisely how many contract, grant, and loan recipient awards have been made, for example, in a particular state. The user can view the jobs created or saved and the total value of the awards. The user can zoom from a larger national overview down to details of individual projects in specific zip codes. Alternatively, the user can traverse through the geospatial representation 800 by double clicking, mouse dragging, searching, or other similar inputs, as will be understood by those having skill in the art. The user can perform the search based on predetermined parameters including state, city, or zip code, or recipient, which will yield information for that particular state, city, zip code area, or recipient respectively. Further, the searching can be performed on various other predetermined parameters including a keyword, a timeline, a threshold, a recipient, a category, a government agency, a financial agency, or other such parameters, without departing from the intended scope of the claims. The category parameter may include a funding category.

The geospatial representation 800 is created with KML integration and runs in an Earth browser environment. A KML file, specifying a set of features (placemarks, images, textual descriptions, graphical objects, and the like), is integrated for display in an Earth browser (geobrowser) implementing the KML encoding. Further, it will be evident to those skilled in the art that the geospatial representation 800 can be viewed in other similar environments, without departing from the intended scope of the claims.

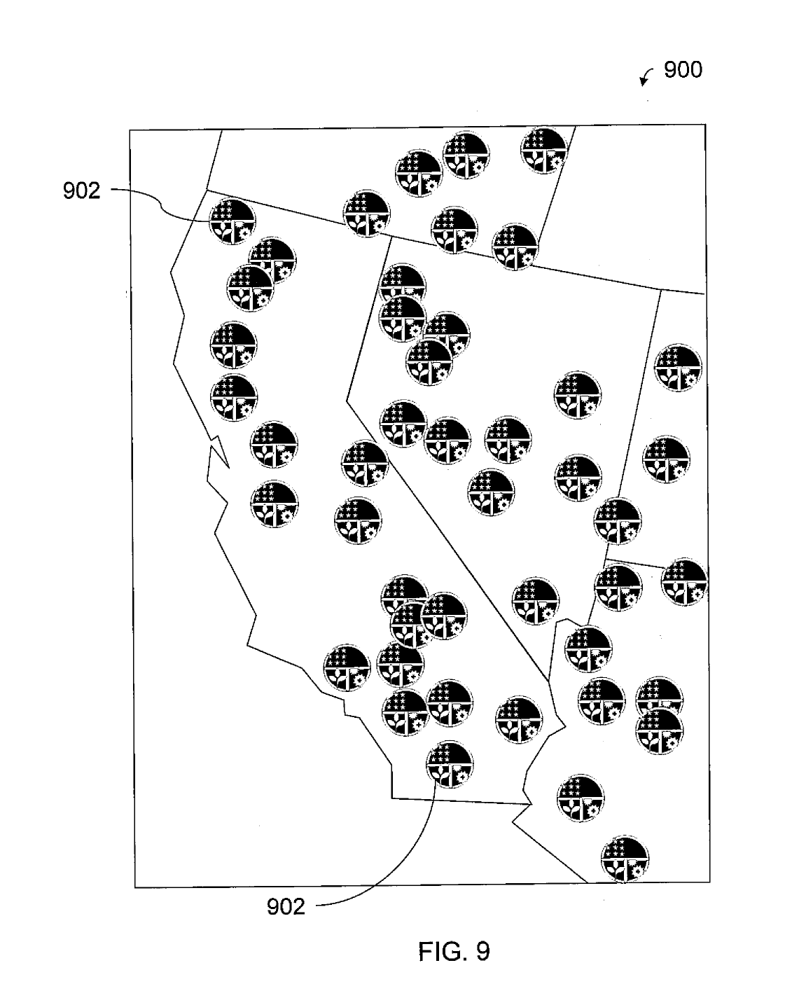

FIG. 9 is an alternate embodiment of the geospatial representation 800 of FIG. 8. A geospatial representation 900 depicts an enlarged view of the state of California. Icons 902 represent areas where stimulus spending has occurred. The user can generate dynamic visual representations and locate precisely how many contract, grant, and loan recipient awards have been made for that particular area, by hovering the mouse over the icon 902. Alternatively, similar information can be viewed by single clicking or double clicking the icon 902. Further, the user can zoom from a larger view down to details of individual projects in specific areas. Additionally, the user can generate visual representations based on multiple factors by performing a state, city, or zip-code search, which will yield information on jobs created and/or saved in congressional districts, the top recipients of stimulus funding, the top infrastructure recipients, and so on for that particular state, city, or zip code area. The geospatial representation 900 can be created in the same manner as described for the geospatial representation 800 of FIG. 8.

FIG. 10 displays an exemplary screenshot 1000 of alerts and notifications. One of the visual representations, as explained in relation with the method 100, can be an alert and notification, which can be generated based on a predetermined timeline, or threshold. For example, a user can generate a visual representation depicting recipients receiving stimulus funding on a particular date. Alternatively, the user can generate visual representations showing all stimulus funding recipients before a particular date. Additionally, the user can view stimulus-funding programs that are over budgeted. Based on such thresholds and timelines, the website 408 can generate notifications and alerts for the user. The screenshot 1000 represents an alert and notification notifying a user that a particular program xyz is over budget by 30%.

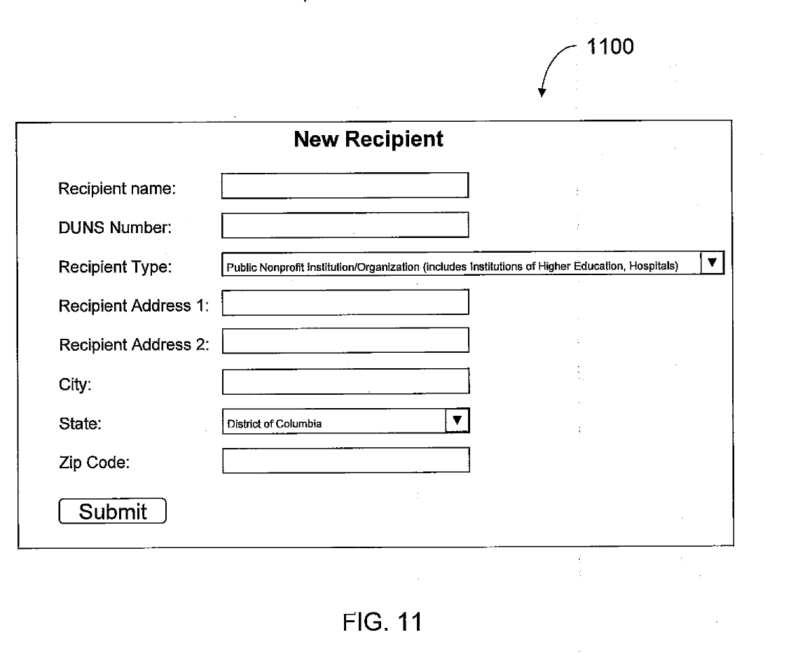

FIG. 11 exhibits an exemplary screenshot of a data entry form 1100. A user, serving as one of the disparate data sources, as described in relation to the method 100, can supply data directly to a centralized database through a user interface. The user interface may have an input device, such as a keyboard or a touch-screen, a storage device, and a display device, so that the user can key-in the data.

A new recipient of stimulus funding may key-in data to a centralized database through the form 1100. For example, a federal agent can use the form 1100 to insert data in fields, such as Recipient Name, DUNS Number, Recipient Type, and so on (illustrated in the form 1100) to add information related to a new recipient of stimulus funding to the centralized database.

The claimed invention offers both telescopic and microscopic views of stimulus funding and projects across the US, from a larger national overview down to details of individual projects in specific zip codes, resulting in a consolidated data management system for aggregating huge amounts of data from disparate data sources, performing analysis, and generating meaningful visual representations of the data efficiently.

The specification has set out a number of specific exemplary embodiments, but persons of skill in the art will understand that variations in these embodiments will naturally occur in the course of embodying the subject matter of the disclosure in specific implementations and environments. It will further be understood that such variations and others as well, fall within the scope of the disclosure. Neither those possible variations nor the specific examples set above are set out to limit the scope of the disclosure. Rather, the scope of claimed invention is defined solely by the claims set out below.

I claim:

1) A computer-implemented method for representing data, comprising:
aggregating data from a plurality of data sources, the sources being organized in a plurality of data formats;
converting the data to a predetermined format and storing the data in a centralized database;
analyzing the data, the analysis including associating data elements and analysis outputs with geographical factors; and
generating visual representations of the analyzed data, based on one or more predetermined parameters.

2) The computer-implemented method of claim 1, wherein the predetermined parameters include one or more of:
a keyword;
a timeline;
a recipient;
a category;
a threshold;
a government agency or
a financial agency.

3) The computer-implemented method of claim 1, wherein the geographical factors include a zip-code.

4) The computer-implemented method of claim 1, wherein the geographical factors include a geographic location.

5) The computer-implemented method of claim 1, wherein the visual representations include one or more of:
a graphical chart;
a map;
a balanced scorecard;
a notification;
an alert;
an icon; or
a color coded graphic.

6) The computer-implemented method of claim 1, wherein the aggregating step is performed periodically.

7) The computer-implemented method of claim 1, wherein a user supplies data directly to the centralized database through a user interface.

8) The computer-implemented method of claim 1, wherein the aggregating step is performed by establishing a Java Database Connectivity (JDBC) connection.

9) The computer-implemented method of claim 1, wherein the visual representations are viewed on a web-based interface.

10) The computer-implemented method of claim 1 further comprising creating data feeds of the analyzed data from the centralized database to the web-based interface.

11) The computer-implemented method of claim 1, wherein the generating step further includes the steps of:
viewing a geospatial representation;
zooming in or out of a particular geographic location within the geospatial representation; and
observing visual representations of the analyzed data related to the particular geographic location.

12) The computer-implemented method of claim 11, wherein the geospatial representation is a map.

13) The computer-implemented method of claim 11 further comprising Keyhole Markup Language (KML) integration for generating the geospatial representation.

14) A computer-implemented visual representation system comprising:
a data aggregation module configured to aggregate data from a plurality of data sources, the sources being organized in a plurality of data formats;
a data storage module, including a centralized database, configured to store the aggregated data, the aggregated data being converted to a predetermined format before storage;
an analysis module configured to associate data elements and analysis outputs with geographical factors;
a network, the analyzed data being transmitted over the network; and
a user interface for viewing visual representations of the analyzed data.

15) The system of claim 14, wherein a JDBC connection is established to connect with the centralized database.

16) The system of claim 14, wherein the user interface is a web-based interface.

17) The system of claim 14, wherein the network is an extranet.

18) A computer-implemented method for representing data, comprising:
aggregating data from a plurality of data sources, the sources being organized in a plurality of data formats;
converting the data to a predetermined format and storing the data in a centralized database;
analyzing the data, the analysis including associating data elements and analysis outputs with geographical factors;
generating visual representations of the analyzed data including a geospatial visual representation;
viewing the geospatial representation;
zooming in or out of a particular geographic location within the geospatial representation; and
observing visual representations of the analyzed data related to the particular geographic location.

19) The computer-implemented method of claim 18 further comprising KML integration for generating the geospatial representation.
